(19) United States
(12) Patent Application Publication
(10) Pub. No.: US 2003/0017828 A1
(43) Pub. Date: Jan. 23, 2003

(54) Methods for mobile communication services selection

(76) Inventors: Michael D. Kotzin, Buffalo Grove, IL (US); Louis Vannatta, Crystal Lake, IL (US); Howard John Thomas, Cirencester, UK (US)

Correspondence Address: Roland K. Bowler II, Motorola, Inc., Intellectual Property Section, Law Department, 600 North U.S. Highway 45, AN475, Libertyville, IL, 60048, US

(21) Appl. No.: 09/909,206

(22) Filed: Jul. 20, 2001

(51) Int. Cl. H04Q 7/20

(52) U.S. Cl. 455/434; 455/552

(57) ABSTRACT

A mobile wireless communication device, for example a cellular handset, for selecting communication services and methods therefore, based on user specified communication objectives related to characteristics of communications executed by the device. The user specified characteristics are used to assess a plurality of communication services by comparing the specified characteristic with corresponding service characteristics of each of a plurality of available communication services. A communication service is selected from the plurality of communication services having service characteristics that correlate most closely with the specified characteristics of the communication executed by the device.

### FIELD OF THE INVENTIONS

The present inventions relate generally to mobile wireless communications, and more particularly to dynamic selection of mobile wireless communication services and/or networks.

### BACKGROUND OF THE INVENTIONS

Presently, mobile wireless communication devices, for example cellular telephones, pagers, wireless communication enabled personal digital assistants (PDAs), etc., are attached or subscribed to a single wireless communication service in a home system or network.

When traveling, or roaming, outside the boundaries of the home network into other networks, the selection of a roaming network service provider is determined by the home service provider according to priorities outside the control of the user of the mobile wireless communication device.

It is desirable in some applications, for example, in data service and Internet enabled mobile wireless communication devices, for the subscriber to have a choice over which network or service provider to utilize, for example to control costs, obtain better service or more or less speed, etc.

The various aspects, features and advantages of the present invention will become more fully apparent to those having ordinary skill in the art upon careful consideration of the following Detailed Description of the Invention and the accompanying drawings described below.

### BRIEF DESCRIPTION OF THE DRAWINGS

FIG. 1 is an exemplary system of one or more networks and a plurality of service providers capable of providing wireless communication services to mobile wireless communication devices.

FIG. 2 is an exemplary process flow diagram for selecting communication services in a mobile wireless communication device.

FIG. 3 is an exemplary process flow diagram for establishing communication objectives in a mobile wireless communication device.

FIG. 4 is an illustration of exemplary user weighted communication characteristics or objectives.

FIG. 5 is a tabular illustration of exemplary service characteristics of a plurality of communication services.

### DETAILED DESCRIPTION OF THE INVENTIONS

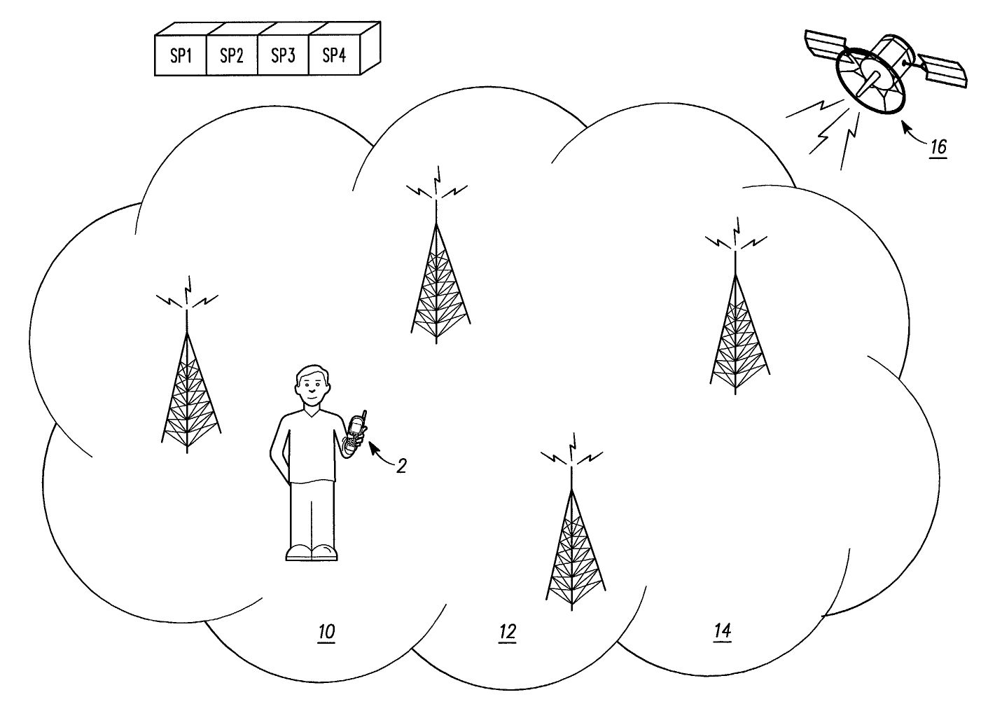

FIG. 1 illustrates a plurality of communication networks with corresponding service providers capable of providing wireless communication services to mobile wireless communication devices. A single wireless communication device 2 is illustrated in the drawing, located within several networks.

The mobile wireless communication devices are generally voice and/or data communication devices, for example, cellular communication handsets, or pagers, or wireless enabled personal digital assistants or other mobile wireless communication devices, including Internet and other network protocol enabled communication devices.

In the exemplary system of networks illustrated in FIG. 1, there are several distinct terrestrial communication networks 10, 12 and 14 and a satellite based communication network 16, all of which provide communication services for overlapping geographical areas via corresponding service providers SP1, SP2, SP3 and SP4.

Alternatively, there is at least one communication network with a plurality of service providers, for example several network resource resellers, providing communication services to network users. More generally, there is a plurality of service providers, some of which are competing with one another, providing wireless communication services on several networks, which serve overlapping geographical areas.

Generally, a mobile wireless communication device user establishes a communication objective at the device for a corresponding communication to be executed by the device. Communications executed by the device include incoming communications received by and outgoing communications originated from the device, for example voice or data or both.

A communication service is then selected from among a plurality of communication service providers capable of providing communication services to the mobile communication device. The selection of the communication service is based on the communication objective for the corresponding communication to be executed by the mobile device. The selected service is preferably one that best serves the user, and more particularly best, or optimally, serves the established communication objectives, for example by providing the least costly service or the fastest data transfer rate, etc.

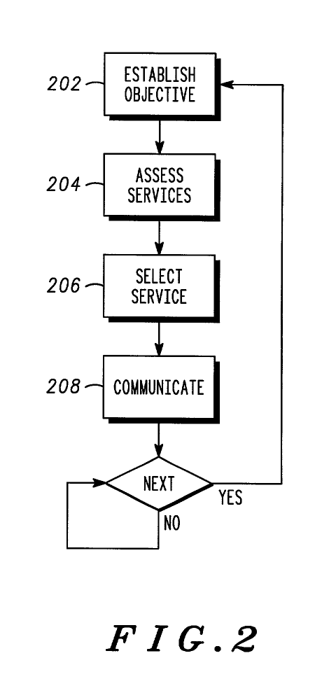

In the exemplary diagram of FIG. 2, at block 202, a mobile wireless communication device user establishes a communication objective at the device for a corresponding communication executed by the device. This may be done prior to or during execution of the communication.

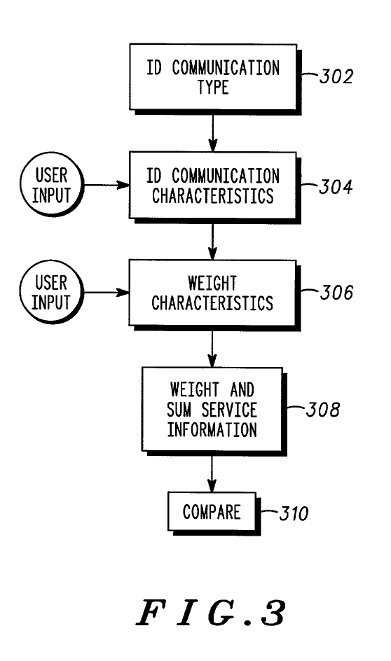

At block 302 of FIG. 3, a communication objective is established by specifying whether a communication executed by the device is a data communication or a voice communication. In some embodiments, the type of communication to be performed may be determined based on whether the communication device is in a data or voice mode, for example by determining which mobility management entity is active or by software detection of some other state or condition or parameter indicative of the type of communication.

The determination of the communication type may be made generally without express or additional user input, although in some embodiments the user may be prompted to input this information. In data or voice only communication devices, making a distinction between the particular communication type, e.g., voice or data, is not required.

Recently there has been a convergence of voice and data communications, for example, voice may be simply carried over a data packet network, as in the Voice Over Internet Protocol (VOIP). Thus in some embodiments, it is not necessary to specify at block 302 whether the communication is voice or data.

In FIG. 3, at block 304, a communication objective is established by identifying, and in some embodiments weighting, at least one characteristic for one or more communications to be executed by the device. A communication objective may be established for either a communication originated at the device or for incoming communications received by the device.

Exemplary communication characteristics include desired or limits on cost and/or tariffs, desired or minimal service quality/reliability, possible latency for message delivery, desired or minimum speed of data transmission, desired air interface reliability, desired or maximum battery usage, among other preferences of the user, including preference for a particular service provider or network.

The communication characteristics may be identified based on input from the user. In one embodiment, the user may identify and weight communication characteristics by making hard or soft entries on the wireless communication device.

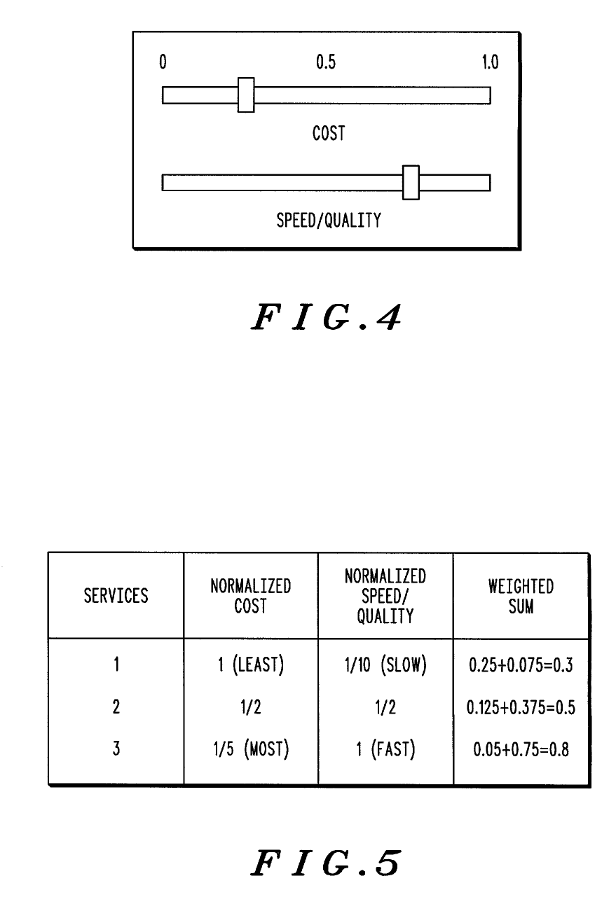

In FIG. 4, for example, the user may select desired “cost” and “speed/quality” characteristics of the communication. In other embodiments, other characteristics besides or in addition to cost, speed and quality may be used. In FIG. 4, the “cost” characteristic has a normalized value of approximately 0.25, and the “speed/quality” characteristic has a normalized value of approximately 0.75 according to a sliding scale.

The user specified communication characteristic information also may be entered numerically or by some other mechanism. In one embodiment, the user prioritizes a communication to be established with a network as having a HIGH or a MEDIUM or a LOW priority. Various characteristics may thus be assigned to the communication depending on the selected priority according to software on the mobile wireless communication device. The prioritization may be made, for example, prior to establishing communication with a network or prior to transmitting data, or alternatively during a communication or transfer.

Thus, for example, a communication having a HIGH priority designation may specify a set of qualitative or quantitative characteristics for a high-speed connection, high quality/reliability service regardless of high cost. A LOW priority designation may specify another set of qualitative or quantitative characteristics for relatively low speed connection, relatively low/reliability service, and a relatively low cost. And a MEDIUM priority designation may specify a set of characteristics that moderate between the HIGH and LOW priority extremes. In other embodiments, other characteristics besides quality, connection speed, and cost may be considered by the priority designation.

In FIG. 2, at block 204, the plurality of communication services are assessed relative to the one or more communication objectives for each communication before selecting one of the communication services. Generally, the plurality of communication services are assessed by comparing the characteristics, or more generally the user specified objectives, of the communication to be executed with corresponding service characteristics of each of a plurality of communication services capable of providing communication services to the device. The purpose of the assessment is to determine which communication service most optimally, or best, satisfies the one or more specified characteristics of the communication to be executed by the communication device.

In one embodiment, service information from the plurality of service providers is transmitted from the network and received by the device for assessment. The communication device may also store the received service information, for example in a portion of memory on the device, and occasionally update the service information, prior to making service selections.

How the service information is communicated to the device depends generally on the particular service information desired for the assessment. In one embodiment, the service information, for example, cost or tariff information, incentive information, etc., is transmitted from service provider to the device in response to a query or request made from the device. Alternatively, the service information may be obtained passively. Quality/reliability of service, for example, may be based on network signal strength measurements made at the communication device.

In FIG. 3, at block 308, characteristics of the communication services corresponding to the communication characteristics, identified at block 304, are weighted with the same weightings applied to the user specified communication characteristics. In embodiments where there is more than one characteristic, the weighted characteristics are summed. In one embodiment, the communication characteristics identified at block 304 and the corresponding characteristics of the communication services are normalized prior to comparison, which is discussed further below.

At block 310, the communication characteristics identified at block 304 are compared with the corresponding communication service characteristics to provide a basis for selection of the communication service that best serves the user at block 206 in FIG. 2.

In the table of FIG. 5, normalized “cost” and “speed/quality” characteristics, or service information, of several communications “Services” are normalized and weighted for comparison with the normalized and weighted communication characteristics identified in FIG. 4. Particularly, the normalized “cost” and “speed/quality” of Services 1, 2 and 3 are weighted with the characteristic weights, 0.25 and 0.75, respectively, applied to the corresponding communication characteristics in FIG. 4.

The weighted summation of the communication characteristics of FIG. 4 (0.25+0.75=1.00) is then compared to the weighted summation of the corresponding characteristics of Services 1, 2 and 3 in FIG. 5. The weighted summation of 0.8 for Service 3 correlates most nearly, or best, with the weighted summation of 1.00 for the characteristics (“Cost” and “Speed/Quality”) identified in FIG. 4, and therefore Service 3 is selected. In other embodiments the assessments or comparisons of the Service may be made differently.

In FIG. 2, at block 206, one of the communication services is selected for the communication to be executed by the device based on the corresponding communication objective established before executing the communication, in other words before establishing communication with the network. The communication service selected from the plurality of communication services preferably has service characteristics that correlate most closely with the identified characteristics of the communication to be executed by the device. The communication service or network may also be selected or changed to another service or network during a communication, for example when the mobile wireless communication device moves outside the range of the selected network or service provider.

In FIG. 2, at block 208, the selected communication service is utilized at least for the communication whose communication objective formed the basis upon which the communication service was selected. The process is repeated for subsequent communications. A default service provider may also be selected.

It may be desirable also to make a service provider or network changes during communications or data transfers, for example based on service availability or changes in the user specified characteristics. Thus in some embodiments, it is desirable to monitor, either dynamically or manually, the service providers and/or network conditions during communications, and to make changes dynamically to optimize the service provider or network selected, as conditions change, for example as the mobile wireless communication device moves about from network to network or between the boundaries of service providers.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method for dynamically selecting communication services from a plurality of service providers capable of providing communication services to a mobile wireless communication device, comprising:
establishing communication objectives at the device for corresponding communications to be executed by the device;
selecting one of the communication services for each communication to be executed by the device based on the corresponding established communication objectives;
utilizing the selected communication service at least for the communication whose communication objective formed the basis upon which the communication service was selected.

2. The method of claim 1, assessing the plurality of communication services relative to the communication objective for each communication before selecting one of the communication services.

3. The method of claim 1, assessing a plurality of communication services relative to the communication objective for each communication during a communication.

4. The method of claim 1, receiving service information from the plurality of service providers at the device, assessing the communication services by comparing the service information received from the corresponding service providers at the device.

5. The method of claim 4, querying the plurality of service providers for service information.

6. The method of claim 4, storing service information received from the service providers at the device, updating service information at the device.

7. The method of claim 1, establishing a communication objective by specifying whether a communication to be executed by the device is a data communication or a voice communication.

8. The method of claim 1, establishing communication objectives by specifying at least one characteristic of a communication to be executed.

9. The method of claim 8, assessing communication services by determining which communication service optimally satisfies the specified characteristics of the communication to be executed.

10. The method of claim 1, establishing communication objectives by weighting at least one characteristic for each communication to be executed.

11. The method of claim 10, assessing the communication services by comparing the weighted characteristics of each communication to be executed to corresponding service characteristics of each of the communication services.

12. The method of claim 11, selecting a communication service having service characteristics that most closely correlate with the weighted characteristics of the communication to be executed.

13. A method for selecting communication services available to a mobile wireless communication device, comprising:
establishing a communication objective at the device by identifying a characteristic of a communication to be executed by the device;
assessing a plurality of communication services by comparing the identified characteristic of the communication to be executed with a corresponding service characteristic of each of a plurality of communication services;
selecting a communication service from the plurality of communication services having the service characteristic that correlates most closely with the identified characteristic of the communication to be executed by the device.

14. The method of claim 13, receiving service information from the plurality of communication services at the device, assessing the plurality of communication services at the device.

15. The method of claim 14, selecting a communication service before executing the communication, and selecting a different communication service during the communication.

16. The method of claim 13,
weighting the one or more identified characteristics of the communication to be executed,
assessing the communication services by comparing the weighted characteristics of the communication to be executed to similarly weighted corresponding characteristics of each of the communication services.

17. A mobile wireless communication device, comprising:
means for identifying a characteristic of a communication to be executed by the device;
means for assessing a plurality of communication services by comparing the identified characteristic of the communication to be executed with corresponding service characteristics of each of a plurality of communication services;
means for selecting a communication service from the plurality of communication services having the service characteristic that correlates most closely with the identified characteristic of the communication to be executed by the device.

18. The device of claim 17, means for receiving service information from the plurality of communication services at the device.

19. The device of claim 18, means for requesting service information from the communication services.

20. The device of claim 17,
means for weighting the identified characteristic of the communication to be executed,
means for comparing the weighted characteristics of the communication to be executed to corresponding service characteristics of each communication service.
